(19) United States
(12) Patent Application Publication
(10) Pub. No.: US 2026/0266729 A1
(43) Pub. Date: Sep. 10, 2026

(54) METHOD AND MICROSCOPE FOR REPEATEDLY IMAGING FLUORESCENT SAMPLES

(71) Applicant: Carl Zeiss Microscopy GmbH, Jena (DE)

(72) Inventors: Hanna Gut, Jena (DE); Volker Doering, Jena (DE); Annette Bergter, Jena (DE)

(73) Assignee: Carl Zeiss Microscopy GmbH, Jena (DE)

(21) Appl. No.: 19/550,839

(22) Filed: Feb. 26, 2026

(30) Foreign Application Priority Data
Mar. 5, 2025 (DE) 10 2025 108 438.6

(51) Int. Cl. G01N 21/64; G02B 21/00

(52) U.S. Cl. CPC G01N 21/6458; G01N 21/6408; G02B 21/0076

(57) ABSTRACT

The invention relates to a method for repeatedly imaging fluorescent samples (5), wherein a sample (5) to be imaged is exposed to illumination radiation for a respective illumination duration at multiple points in time over an imaging time period, and this brings about an emission of fluorescence; emitted fluorescence is collected by means of a detection optics unit (6), captured by a detector (8) and kept available for imaging as measurement values which are assigned to the times of their capture and an image is generated at least for selected times.

The invention is characterized in that the dynamic range of the detector (8) for the fluorescence to be captured is used as a starting point to define an intensity threshold value, with the latter being exceeded causing an adjustment of the operating parameters of an illumination light source (2), which provides the illumination radiation, and/or of the detector (8) such that the threshold value is undershot/again met; and the operating parameters are adjusted if the intensity of the captured fluorescence exceeds the threshold value.

The invention relates to a method according to the preamble of the main claim and to a microscope according to the subject matter of the alternative independent claim.

When live biological samples, for example cells, tissues, organoids or small organisms, are examined using fluorescence microscopy, the intention increasingly is to capture multiple images over relatively long time series in order for example to observe relatively long-lasting processes. Such time series may extend over several hours or days. The samples may have been genetically modified in order to be able to emit fluorescence, which can be captured as detection radiation and used for imaging. Another option lies in providing certain structures of the sample with fluorescence markers (chemical fluorophores). In both cases, the emission of fluorescence can be brought about by illuminating the sample using an excitation radiation at a suitable wavelength and with sufficient intensity.

Expediently, the technical settings for an image acquisition, i.e. for detecting and evaluating the fluorescence collected by a detection optics unit, are chosen in advance such that the dynamic range of a utilized detector is used well, but a saturation of the detector or of its detector elements is avoided.

As a consequence of increased expression of a fluorescent molecule or on account of a locally increased enrichment (internalization) of fluorescence markers, the emitted fluorescence may have high intensities over the course of the time series. These elevated intensities may lead to the dynamic range of the detector being exceeded, at least with regard to some regions in the sample. As a result, the relevant image regions cannot be evaluated, in particular not accurately quantified.

The problem addressed by the invention is that of reducing disadvantages of the prior art and of producing time series of fluorescence images without leaving the dynamic range of utilized detectors. In this respect, the intention is to propose a suitable method and a correspondingly configured device.

This problem is solved by a method according to the subject matter of Claim 1 and by a microscope according to the alternative independent claim. The dependent claims relate to advantageous developments.

The problem is solved in a method for repeatedly imaging fluorescent samples, wherein a sample to be imaged is exposed to illumination radiation for a respective illumination duration at multiple points in time over an imaging time period. The illumination radiation brings about an emission of fluorescence in the sample. As already mentioned above, this may occur as a consequence of a genetic modification of the sample and/or as a result of chemical fluorophores. The fluorophores suitable for exciting fluorescence may have been introduced into and/or onto the sample in advance. Moreover, they may be provided with binding sites (linkers) in order to be able to bind largely selectively to predetermined structures of the sample to be labeled.

Emitted fluorescence is collected by means of a detection optics unit and captured by a detector. The acquired measurement values are assigned to the respective times of their acquisition and are kept available for imaging, i.e. for a subsequent evaluation and optional image-based processing. Within the imaging process, an image is generated—at least for selected points in time—on the basis of the measurement values acquired in each case.

According to the invention, the method is characterized in that the dynamic range of the detector for the fluorescence to be captured, in particular for the wavelength or wavelength range thereof, is used as a starting point to define an intensity threshold value, with the latter being exceeded causing an adjustment of the operating parameters of an illumination light source, which provides the illumination radiation, and/or of the detector. The effect of adjusting the operating parameters is that the threshold value is met again or undershot.

In an alternative to that or in addition, it is also possible for a threshold value to be defined at the lower end of the dynamic range. Operating parameters of the illumination light source, which provides the illumination radiation, and/or of the detector can be adjusted if said threshold value is undershot. The effect of adjusting the operating parameters is that the threshold value is met again or exceeded. Hereinafter, reference is substantially made to the upper threshold value being met and hence to a saturation of the detector or of detector elements being avoided.

The invention can be used both in, for example, confocal image acquisition and in wide-field imaging. Accordingly, illumination can be effected in punctiform fashion, as a line or as wide-field illumination (reflected light, transmitted light, light sheet).

The intensity threshold value is chosen on the basis of the fluorescence to be captured and the dynamic range of the detector. Here, the dynamic range is a range of signal strengths (intensities) over which signals can be detected and distinguished from one another. In particular, fluorescence signals are distinguished from background noise at a lower limit of the dynamic range, while saturation of the detector is (just) still avoided at an upper limit of the dynamic range. The dynamic range can be taken from technical documentation of the detector or ascertained individually for the detector. This also applies analogously if the detector is composed of a number of individual detector elements, as is the case, for example, with two-dimensional detectors such as SPAD arrays, CMOS, sCMOS or CCD detectors.

The actual dynamic range of a detector or of its detector elements can be ascertained by virtue of, for example, a reference sample with known properties being illuminated and the resulting captured detection radiation being evaluated. In this way, it is also possible to take account of influences which arise on account of the optically effective elements present in the illumination beam path and/or in the detection beam path.

In contrast to the prior art, the actually emitted and captured fluorescence is used to regulate the relevant measurement variable in the case of the invention described here. Said measurement variable is moreover related to the dynamic range of the utilized detector.

In order to explain the invention, reference is made below to a Cartesian coordinate system, the z-axis of which points in the direction of a detection axis. An image plane extends in the xy-plane.

In particular, the invention makes it possible to prevent saturation of the detector or of its detector elements. This may take place once or else several times per imaging time period.

Since there is a linear relationship between the intensity of the illumination radiation emitted on the part of the illumination light source and the sensitivity of the detector or of the detector elements, the intensities of the individual measurement values or images can be related to one another once the acquisition of the time series (imaging time period) has been completed. In this way, a sequence of individual images that can be correctly quantified is obtained.

The method can be used if measurement values of an image are acquired at a specific point in time. However, it is also possible for measurement values of different images to be acquired at respective times in quick succession. For example, regions of the sample which are defined at one z-position or at different z-positions in the detection direction (direction of the z-axis; z-direction) can be measured quickly in succession or simultaneously (see below).

In one configuration, the method can be applied when all detector elements exceed the threshold value. In a further configuration, the operating parameters can be adjusted if at least some detector elements of the detector exceed the intensity threshold value (also referred to herein as threshold value for short).

In a refinement of the method, a small number of the detector elements, for example ≤10%, ≤5% or ≤2% of the detector elements, exceeding the threshold value can be tolerated, and an adjustment of the operating parameters can be dispensed with. If required, it is thus possible to react to the behavior or malfunctions of individual detector elements.

The method according to the invention can be applied in order to adjust the operating parameters, wherein the intensity of the illumination radiation is adjusted, in particular reduced, by virtue of the illumination light source being controlled and regulated accordingly when the threshold value is exceeded. In addition to that or in an alternative, the sensitivity and/or the exposure time of the detector can be adjusted, in particular reduced, by virtue of the detector being controlled and regulated accordingly when the threshold value is exceeded. An implemented adjustment of the operating parameters may be indicated to a user, for example in order to inform said user about the adjustment per se and the scope thereof.

Within the scope of the present invention, adjustments of the operating parameters performed being logged in an assigned manner to the corresponding measurement values is advantageous for a subsequent evaluation of the measurement values and an image generation. The sample is exposed to the illumination radiation for an illumination duration at specific points in time during the imaging time period, during which a time series is acquired in particular, and fluorescence brought about is captured as detection radiation. Both the points in time, for example the respective start of the illumination duration, and the length of the illumination duration as well as the intensities of the illumination light source and/or the associated sensitivity and/or exposure time of the detector can be logged in an assigned manner to the measurement values (metadata). These data can be used to normalize the measurement values (see below). For example, it is possible to create a data record in which all grayscale value levels can be represented in the same grayscale value space despite interim adjustments to the operating parameters. Moreover, the time series and experiments can be understood and reproduced as a result. For example, should the measurement values acquired be used as training data for artificial intelligence models, documentation of the operating parameter adjustments is also useful for this purpose.

Adjusting the operating parameters over the course of an imaging time period means that the measurement values acquired at the individual points in time may be based on different technical assumptions. Therefore, in one configuration of the method according to the invention, measurement values acquired during different illumination durations within the imaging time period and, in each case, under different operating parameters are normalized to a common grayscale value range. The aforementioned logs and the technical relationships between illumination intensity, intensity of the fluorescence and the sensitivity or exposure time of the detector can be used for this purpose.

The method according to the invention allows long imaging time periods of hours and days. Comparatively long periods of time may lie between the individual measurement value acquisition times, especially if the intention is for slow-running processes to be examined and documented using images. In order to avoid the case where the conditions in the sample have changed to such an extent since the most recent measurement value has been acquired that it is no longer possible to acquire usable measurement values at a later stage using the most recently set operating parameters, it is possible to perform a test acquisition before selected acquisitions of measurement values in a development of the method according to the invention. Said test acquisition is used to measure and evaluate a currently present intensity value of the fluorescence, at least for regions of the detector, for example for selected detector elements. The operating parameters are adjusted if the threshold value is exceeded. Only then are further measurement values acquired for imaging purposes. Naturally, such test acquisitions are advantageously also logged.

It is possible to provide for a test acquisition whenever a specific minimum duration elapses between the individual points in time at which measurement values are acquired. It is also possible to use the previous measurement values from the preceding points in time to estimate whether an operating parameter adjustment is probable the next time measurement values are acquired. For example, such an estimate may consider the development of the measured intensity values over the previous measurement value acquisitions. Performing a test acquisition may depend on the result of this estimate.

For example, test acquisitions may also be applied if multiple images which lie one above the other in a detection direction (z-direction), i.e. which form what is known as a z-stack, are recorded at one point in time during the illumination duration. Should a test acquisition be performed, a z-coordinate within the z-stack, for example approximately in the center thereof, is advantageously chosen.

In further configurations, the method according to the invention may be related to measurement values of individual detector elements of the detector. In this case, information relating to a currently present intensity of the fluorescence is compared with the threshold value for each detector element of the detector, and the operating parameters are adjusted if said threshold value is exceeded. Such a procedure can increase the sensitivity of the method since the threshold value being exceeded by one or a few detector elements can already be used to adjust the operating parameters.

A comparison of the currently measured intensity values per detector element can also be used to adjust the operating parameters only when the threshold value is determined to be exceeded at a minimum number of detector elements (see also above). In this way, it is for example possible to take account of the individual behavior of individual detector elements, including malfunctions such as excessively sensitive detector elements (“hot pixels”).

In a refinement, the invention can be used for imaging different locations of the sample. Thus, images of different locations are captured and stored simultaneously at a given point in time (multi-position acquisition). In the process, whether the threshold value is exceeded is checked at least for selected locations, and/or a test acquisition is performed between two acquisitions of measurement values for imaging purposes, at least for selected locations.

The locations at which current intensities are compared with the threshold value may already be selected before the start of the time series measurement. The locations may also be selected on the basis of measurement values acquired during the time series such that it is also possible to choose different locations for the threshold value comparison over the duration of a time series.

The method according to the invention can be performed using an appropriately configured optical device in particular, especially using a microscope.

A suitable microscope allows repeated imaging of fluorescent samples and comprises an illumination light source, for example a laser light source, for controlled and regulated provision of an illumination radiation along an illumination beam path at specific points in time over a respective illumination duration in an imaging time period. A detection optics unit is present for collecting fluorescence emitted by the sample in particular. An imaging optics unit serves to guide the fluorescence along a detection beam path. In a simple embodiment of the microscope, the imaging optics unit may be the same as the detection optics unit. A detector arranged in the detection beam path serves to capture the fluorescence as measurement values which are assigned to the times of their acquisition. Thus, acquired measurement values are assigned the respective point in time of acquisition, and these are stored together. A controller is used to generate and provide control commands that serve to regulate operating parameters of the illumination light source and/or of the detector.

A microscope according to the invention is characterized by a manual and/or an automatic input device, by means of which an intensity threshold value can be specified. Such an input device may be a keyboard, a voice controller, a touch-sensitive surface (touch pad) or the like. In this case, a dynamic range of the detector for the fluorescence to be captured, for example for the wavelength thereof and/or the expected intensity, is used as a starting point to define the intensity threshold value. The controller, for example in the form of a computer, microcontroller or FPGA (field programmable gate array), is configured in such a way that operating parameters of the illumination light source and/or of the detector are adjusted in such a way when the intensity threshold value is exceeded that the threshold value is undershot or again met. If a lower threshold value is additionally defined, the operating parameters are accordingly adjusted in such a way that the lower threshold value is again met or exceeded.

The illumination light source should be linearly controllable, i.e. the output power thereof should be able to be set continuously within the technically imposed range. A linear controllability is also understood to mean control at discrete levels, especially if these are distributed largely uniformly over the technically imposed adjustment range of the illumination light source.

In a further embodiment of the invention, a neutral density filter is arranged downstream of the illumination light source. An intensity of the provided illumination radiation can be set and regulated by virtue of controlling the neutral density filter on its own or together with the illumination light source. The neutral density filter may be a constituent part of the illumination light source.

The detector comprises at least one detector element and may be for example in the form of a secondary electron multiplier (photomultiplier tube, PMT). The microscope according to the invention may therefore be in the form of a confocal microscope, for example a laser scanning microscope. Further embodiments might perform confocal scanning of the sample but implement detection using an area detector which has multiple detector elements that can preferably be read out individually. For example, such a detector can be an array of avalanche photodiodes, for example an APD array (avalanche photodiode array). Such an area detector also allows switching between different detection methods. For example, it is possible to switch between punctiform scanning and areal image acquisition (wide field) without having to keep different detectors available for this purpose. The method according to the invention can be used for both detection methods.

Within the scope of the invention, CMOS, sCMOS or SPAD (single photon avalanche diode) arrays may also be used as the detector. The exposure time or the sensitivity can be adjusted for the detector in general or—if possible, from a technical point of view—separately for the detector elements.

For example, a RAM, ROM, electronic storage medium and/or virtual memory (cloud) may be present as a memory for keeping the acquired and assigned measurement values available for imaging purposes. In addition to the measurement values and the points in time, the memory may optionally store coordinates of the respective locations, utilized operating parameters and information regarding the sample, for example, in a repeatedly retrievable manner. The evaluation unit for analyzing the acquired measurement values can be a computer, an FPGA and/or a virtual application (cloud-based), for example.

For example, the invention can be used for imaging living biological samples such as cell lines, organoids and small model organisms over relatively long periods of time. For example, recurring image acquisitions over periods of hours or days are possible. Despite possibly changing conditions during the acquisition of measurement values, especially in the case of increasing intensities of the excited fluorescence, it is possible to remain within the dynamic range of the detector, and a saturation of the detector or individual detector elements can be avoided.

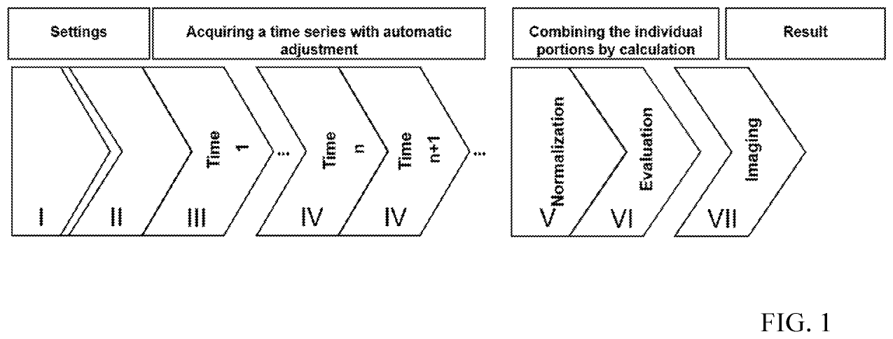

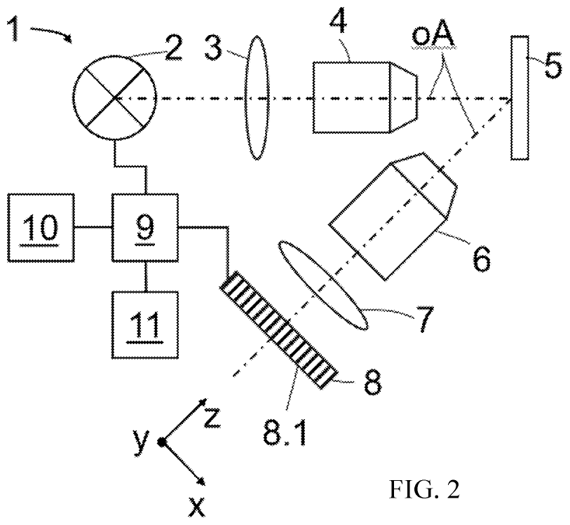

The method according to the invention is explained step-by-step below on the basis of one possible configuration. The procedure is shown schematically in FIG. 1. FIG. 2 schematically shows a microscope by means of which the method according to the invention can be carried out.

Before the start of the actual measurements, the sample to be imaged is selected. Should this not have happened previously, said sample is optionally labeled with fluorophores and/or genetically modified such that fluorescence can be excited in the sample by means of a suitable excitation radiation (step I).

Once the sample has been selected, the frequency and duration of exposure (exposure time) and imaging over the course of the imaging time period is defined for the regions of the sample in accordance with the desired examination aims in a step II. For example, imaging regimes are determined in order to perform imaging in an xy-plane or in a z-stack. The points in time at which the measurement values are acquired is also defined. The points in time may be chosen absolutely or relative to the start time of the imaging time period.

The technical imaging specifications are also defined. These include the selection of the wavelength or wavelengths of the illumination radiation and the intensity of the illumination radiation.

The technical properties of the detector such as the sensitivity and its dynamic range are ascertained from technical documents and/or on the basis of investigations and test measurements.

The intensity threshold value, the exceeding of which leads to an adjustment of the operating parameters, can be defined with knowledge of the above-mentioned boundary conditions and operating parameters. Moreover, the relationship between value of exceedance and the adjustment is defined. It is optionally possible to set a lower threshold value which, if undershot, likewise leads to an adjustment of the operating parameters.

Merely by way of example, the initial intensity of the illumination radiation at the illumination light source and/or the sensitivity of the detector may be reduced by 10 percent, for example.

The operating parameters can likewise be adjusted in steps when the threshold value is exceeded by certain value intervals. In another configuration of the method, the adjustment is continuous and depends on the amount by which the threshold value is exceeded. The adjustment is logged and stored.

The direction and magnitude of the adjustments to be implemented may be established in advance and made available as retrievable data. Thus, test measurements in advance can be used to establish the adjustments which are required at specific intensity values in order to fall below the threshold value again. Simulations with which the behavior of an imaging system including the respective sample type is estimated and necessary adaptation rules are stored are also possible. For example, information relating to the adjustments may be kept available in a retrievable manner, for example in tables (look-up tables, LUT) or as mathematical functions.

Once the operating parameters have been adjusted, the imaging time period starts, and the acquisition of a time series with automatic adjustment is started. In the process, sample acquisition is performed, and the measurement values obtained in the process are stored in a manner assigned to the time of acquisition and are optionally fed to immediate or later evaluation (step III).

The collection of measurement values at the predetermined points in time and, where necessary, the adjustment of the operating parameters, i.e. the illumination intensity and/or the exposure time and/or the sensitivity of the detector or of the detector elements, can be performed multiple times over the imaging time period (step IV).

In a modification of the method, the times of subsequent measurement value acquisitions may be adjusted on the basis of the image analysis results. For example, this is possible if the images from the previous acquisitions exhibit a more dynamic behavior of the observable processes in the sample than was originally assumed. Accordingly, the times of subsequent acquisitions can be chosen to be further apart if the process to be imaged proceeds more slowly than expected.

Once the imaging time period has ended, the acquired measurement values are normalized in accordance with the operating parameters effective at the respective points in time (step V). In the process, the measurement values acquired at the respective times are compared and related to the respective operating parameters. If no adjustments were made during the imaging time period, the grayscale values from the individual measurements or the resultant images can be compared directly with one another. By contrast, if adjustments were made, the grayscale values obtained with different operating parameters are normalized, i.e. brought into a common grayscale value space. The optionally normalized measurement values from the individual points in time are subsequently evaluated (evaluation, step VI). Subsequently, images comparable to one another can be generated, displayed and/or stored (step VII).

The method according to the invention can be carried out using a microscope 1, which is depicted schematically in FIG. 2. Starting from an illumination light source 2, an illumination radiation is provided along an optical axis oA and directed at a sample 5 by means of optical elements, for example by means of optical lenses 3 and/or by means of an illumination objective 4. Fluorescence excited in the sample 5 is captured by a detection optics unit 6, for example by a detection objective, and steered along a detection beam path, optionally with the cooperation of optical lenses as an imaging optics unit 7, to a detector 8, where it is imaged. The detector 8 comprises a number of detector elements 8.1 (indicated in the figure) and is connected to a controller 9, for example in the form of a computer, a microcontroller or an FPGA, in a manner suitable for exchanging data and control commands. An evaluation unit 10, for example a computer or an FPGA, configured to evaluate measurement values acquired by the detector 8 is connected to the controller 9. The controller 9 and/or the evaluation unit 10 may comprise a memory in which the measurement values, evaluation results, meta data and, optionally image data can be stored in a repeatedly retrievable manner. It is also possible for there to be a separate memory (not shown), for example in the form of a memory drive, a RAM drive or a cloud (virtual memory drive). The controller 9 is also connected to the illumination light source 2. A lower and/or an upper threshold value for the intensity of the captured fluorescence (measurement values of the detector 8) is stored in the controller 9, and the operating parameters of the illumination light source 2 and/or of the detector 8 are adjusted if said threshold values are undershot and exceeded, respectively. The controller 9 is configured to generate control commands on the basis of obtained measurement values of the detector 8 and/or on the basis of obtained measurement values of the evaluation unit 10 in comparison with the currently stored threshold values, the execution of said control commands leading to an adjustment of the operating parameters of the illumination light source 2 and/or of the detector 8. The aim here is that the intensities of the captured fluorescence (measurement values) again meet or exceed the lower threshold value or again meet or undershoot the upper threshold value. The threshold values can be transmitted to the controller 9 by means of an automated or manual input device 11.

### REFERENCE SIGNS

1 Microscope
2 Illumination light source
3 Optical lens
4 Illumination objective
5 Sample
6 Detection optics unit
7 Imaging optics unit
8 Detector
8.1 Detector elements
9 Controller
10 Evaluation unit
11 Input device
oA Optical axis

1: A method for repeatedly imaging fluorescent samples, the method comprising:
exposing a sample to be imaged to illumination radiation for a respective illumination duration at multiple points in time over an imaging time period, bringing about an emission of fluorescence;
collecting emitted fluorescence by a detection optics unit, capturing the emitted fluorescence by a detector and keeping the emitted fluorescence available for imaging as measurement values which are assigned to the times of their capture, and
generating an image at least for selected times,
wherein
the dynamic range of the detector for the fluorescence to be captured is used as a starting point to define a lower and/or an upper intensity threshold value, with the latter being undershot or exceeded causing an adjustment of the operating parameters of an illumination light source, which provides the illumination radiation, and/or of the detector such that the threshold value is again met or exceeded, or again met and undershot; and
the operating parameters are adjusted if the intensity of the captured fluorescence drops below the lower threshold value or exceeds the upper threshold value.

2: The method according to claim 1, wherein if the lower threshold value is undershot or the threshold value is exceeded, the intensity of the illumination radiation is adjusted by virtue of the illumination light source being controlled and regulated accordingly.

3: The method according to claim 1, wherein if the lower threshold value is undershot or the threshold value is exceeded, the sensitivity and/or the exposure time of the detector is adjusted by virtue of the detector being controlled and regulated accordingly.

4: The method according to claim 1, wherein adjustments of the operating parameters performed are logged in an assigned manner to the corresponding measurement values.

5: The method according to claim 1, wherein measurement values acquired during different illumination durations within the imaging time period and, in each case, under different operating parameters are normalized to a common grayscale value range.

6: The method according to claim 1, wherein selected acquisitions of measurement values are preceded by a test acquisition, during which a currently present intensity value is measured and evaluated at least for some detector elements of the detector, and the operating parameters are adjusted before measurement values are acquired for imaging purposes if the lower threshold value is undershot or if the upper threshold value is exceeded.

7: The method according to claim 6, wherein multiple images lying one above the other in a detection direction (z-direction) are recorded (z-stack), and a z-coordinate within the z-stack is chosen for the test acquisition.

8: The method according to claim 1, wherein information relating to a currently present intensity of the fluorescence is compared with the threshold value for each detector element of the detector, and the operating parameters are adjusted if said threshold value is undershot or exceeded.

9: The method according to claim 8, wherein the operating parameters are only adjusted once the threshold value is undershot or exceeded at a minimum number of detector elements.

10: The method according to claim 1 for imaging different locations of the sample at different points in time, wherein measurement values from multiple locations are acquired and stored at a given point in time, wherein
undershooting and/or exceeding the threshold value is checked at least for selected locations, and/or
a test acquisition is performed between two acquisitions of measurement values for imaging purposes at least for selected locations.

11: A microscope for repeated imaging of fluorescent samples, the microscope comprising:
an illumination light source for controlled and regulated provision of an illumination radiation along an illumination beam path at specific points in time over a respective illumination duration in an imaging time period;
a detection optics unit for collecting an emitted fluorescence;
an imaging optics unit for guiding the fluorescence along a detection beam path;
a detector for capturing the fluorescence as measurement values which are assigned to the times of their acquisition, and
a controller for regulating operating parameters of the illumination light source and/or of the detector,
wherein
a manual and/or an automatic input device is present, by which a lower and/or an upper intensity threshold value is configured to be specified, with the lower and/or upper intensity threshold values being defined using as a starting point a dynamic range of the detector for the fluorescence to be captured,
the controller is configured in such a way that, if the lower intensity threshold value is undershot or if the upper intensity threshold value is exceeded, operating parameters of the illumination light source and/or of the detector are adjusted such that the threshold value is exceeded again or undershot and again met.
